(19) United States
(12) Patent Application Publication
(10) Pub. No.: US 2021/0178860 A1
(43) Pub. Date: Jun. 17, 2021

(54) VEHICLE AIR CONDITIONING APPARATUS

(71) Applicant: SANDEN AUTOMOTIVE CLIMATE SYSTEMS CORPORATION, Isesaki-shi, Gunma (JP)

(72) Inventors: Tetsuya ISHIZEKI, Isesaki-shi, Gunma (JP); Megumi SHIGETA, Isesaki-shi, Gunma (JP)

(73) Assignee: SANDEN AUTOMOTIVE CLIMATE SYSTEMS CORPORATION, Isesaki-shi, Gunma (JP)

(21) Appl. No.: 17/272,903

(22) PCT Filed: Aug. 8, 2019
(86) PCT No.: PCT/JP2019/031365

§ 371 Date: Mar. 2, 2021

(30) Foreign Application Priority Data
Sep. 21, 2018 (JP) 2018-177217

(51) Int. Cl. B60H 1/22; B60H 1/00

(52) U.S. Cl. CPC B60H 1/2218; B60H 1/00878; B60H 2001/00957; B60H 2001/00942; B60H 2001/00928

(57) ABSTRACT

There is provided a vehicle air conditioning apparatus capable of saving the installation space of the components equipped in the vehicle and reducing the manufacturing cost, by sharing the heat source in the vehicle. The vehicle air conditioning apparatus includes a heat medium circuit to which a heat medium heater configured to heat a heat medium and a battery B are connected to allow the battery B to be heated by the heat medium flowing therethrough. The heat medium circuit includes a heat medium heat releasing unit which is provided downstream of the heat medium heater and upstream of the battery B in a heat medium flow direction, and configured to release the heat from the heat medium to the air to be supplied to the vehicle compartment.

### TECHNICAL FIELD

The present invention relates to a vehicle air conditioning apparatus applicable to a vehicle equipped with a component which needs to adjust its temperature in use, for example, a battery for supplying electric power to an electric motor to drive the vehicle.

### BACKGROUND ART

Conventionally, this sort of vehicle air conditioning apparatus includes, for example, a refrigerant circuit including a compressor, an indoor heat exchanger, an outdoor heat exchanger, and expansion valves, and is configured to cool, heat, and dehumidify a vehicle compartment by supplying the vehicle compartment with the air having been subjected to a heat exchange with the refrigerant in the indoor heat exchanger.

In addition, as a vehicle equipped with this vehicle air conditioning apparatus, there has been known an electric car and a hybrid car including a component which needs to adjust its temperature in use, for example, a battery for supplying electric power to an electric motor as a drive source.

Therefore, the component equipped in the vehicle, which needs to adjust its temperature, is connected to a heat medium circuit to heat a heat medium flowing through the heat medium circuit by a heat medium heater, so that the component is heated by the heated heat medium (see, for example, Patent Literature 1).

### CITATION LIST

### Patent Literature

PTL1: Japanese Patent Application Laid-Open No. H10-12286

### SUMMARY OF INVENTION

### Technical Problem

The above-described vehicle needs a plurality of heat sources, for example, a heat medium heater used for a heating operation of the vehicle air conditioning apparatus and also used in the heat medium circuit. Therefore, the vehicle needs a large space to install the plurality of heat sources, and increases the manufacturing cost due to an increase in the number of parts.

It is therefore an object of the invention to provide a vehicle air conditioning apparatus capable of saving the installation space of the components equipped in the vehicle and reducing the manufacturing cost, by sharing the heat source in the vehicle.

### Solution to Problem

To achieve the object, according to the invention, the vehicle air conditioning apparatus is configured to adjust a temperature and a humidity of air in a vehicle compartment and includes a heat medium circuit to which a heat medium heater configured to heat a heat medium and a component of a vehicle are connected to allow the component to be heated by the heat medium flowing therethrough. A heat medium heat releasing unit is connected to the heat medium circuit. The heat medium heat releasing unit is provided downstream of the heat medium heater and upstream of the component in a heat medium flow direction, and configured to release the heat from the heat medium to the air to be supplied to the vehicle compartment.

By this means, the air to be supplied to the vehicle compartment is heated by the heat medium which has been heated by the heat medium heater configured to heat the components of the vehicle, and therefore it is possible to use the heat medium heater as a heat source for the heating operation.

### Advantageous Effect

According to the vehicle air conditioning apparatus of the invention, the heat medium heater can be used as a heat source for the heating operation. Therefore, it is possible to perform the heating operation and heat the components by one heater. Consequently, it is possible to save the installation space of the components in the vehicle, and reduce the manufacturing cost.

### BRIEF DESCRIPTION OF DRAWINGS

FIG. 1 schematically illustrates the configuration of a vehicle air conditioning apparatus according to an embodiment of the invention;

FIG. 2 schematically illustrates the vehicle air conditioning apparatus for a battery cooling operation and a heating assistive operation; and

FIG. 3 schematically illustrates the vehicle air conditioning apparatus for a battery heating and heating assistive operation.

### DESCRIPTION OF EMBODIMENTS

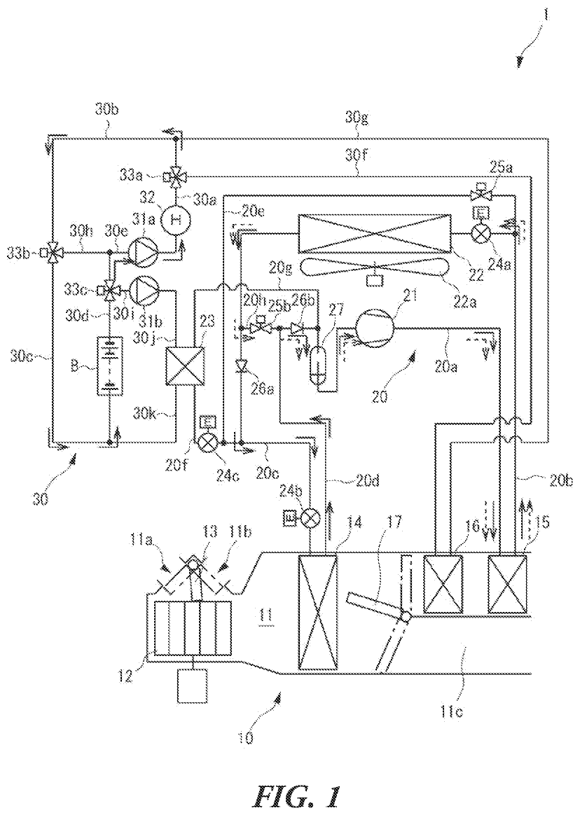

FIGS. 1 to 3 illustrate an embodiment of the invention.

A vehicle air conditioning apparatus 1 according to the invention is applicable to a vehicle such as an electric car and a hybrid car, which can be driven by the driving force of an electric motor.

The vehicle includes an electric motor for driving the vehicle, and a traction battery B as a component for supplying electric power to the electric motor. The battery B generates heat when being used. In addition, the battery B is required to be used at temperatures in a predetermined range to exert a predetermined performance. Accordingly, the battery B needs to be cooled and heated depending on the outside air temperature and the usage condition. It is preferred that the battery B is used at temperatures, for example, in a range of 10 to 30 degrees Celsius.

As illustrated in FIG. 1, this vehicle air conditioning apparatus 1 includes: an air conditioning unit 10 provided in the vehicle compartment of the vehicle; a refrigerant circuit 20 provided across the vehicle compartment and the outside of the vehicle compartment; and a heat medium circuit 30 that allows a heat medium for absorbing the heat released from the battery B and heating the battery B to flow therethrough.

The air conditioning unit 10 includes an air flow passage 11 that allows the air supplied to the vehicle compartment to flow therethrough. An outdoor air inlet 11a and an indoor air inlet 11b are provided in one end side of the air flow passage 11. The outdoor air inlet 11a is configured to allow the air outside the vehicle compartment to flow into the air flow passage 11, and the indoor air inlet 11b is configured to allow the air in the vehicle compartment to flow into the air flow passage 11. Meanwhile, a foot outlet, a vent outlet and a defroster outlet (not shown) are provided in the other end side of the air flow passage 11. The foot outlet is configured to allow the air flowing through the air flow passage 11 to blow to the feet of the passengers. The vent outlet is configured to allow the air flowing through the air flow passage 11 to blow to the upper bodies of the passengers. The defroster outlet is configured to allow the air flowing through the air flow passage 11 to blow to the surface of the front window in the vehicle compartment.

Also, an inlet switching damper 13 is provided in the one end side of the air flow passage 11 and configured to be able to open one of the outdoor air inlet 11a and the indoor air inlet 11b and close the other. The inlet switching damper 13 can switch the mode of the inlets among: an outdoor air supply mode to close the indoor air inlet 11b and open the outdoor air inlet 11a; an indoor air circulating mode to close the outdoor air inlet 11a and open the indoor air inlet 11b; and an indoor and outdoor air suction mode to open both the outdoor air inlet 11a and the indoor air inlet 11b by disposing the inlet switching damper 13 between the outdoor air inlet 11a and the indoor air inlet 11b.

An indoor blower 12 such as a sirocco fan is provided in the one end side of the air flow passage 11 and configured to allow the air to flow through the air flow passage 11 from the one end side to the other end side.

A heat absorbing unit 14 is provided downstream of the indoor blower 12 in the air flow direction of the air flow passage 11. The heat absorbing unit 14, as an indoor heat exchanger, is configured to cool and dehumidify the air flowing through the air flow passage 11. In addition, a heat releasing unit 15 is provided downstream of the heat absorbing unit 14 in the air flow direction of the air flow passage 11. The heat releasing unit 15, as an indoor heat exchanger, is configured to heat the air flowing through the air flow passage 11.

The heat releasing unit 15 is disposed in one side of the orthogonal direction of the air flow passage 11, and a heat releasing unit bypass flow passage 11c is formed in the other side of the orthogonal direction of the air flow passage 11 to bypass the heat releasing unit 15. In the one side of the orthogonal direction of the air flow passage 11, a heat medium heat releasing unit 16 is provided between the heat absorbing unit 14 and the heat releasing unit 15 and configured to heat the air to be supplied to the vehicle compartment by a heat exchange between the heat medium flowing through the heat medium circuit 30 and the air.

An air mix damper 17 is provided between the heat absorbing unit 14 and the heat medium heat releasing unit 16 in the air flow passage 11, and configured to control the percentage of the air to be heated by the heat releasing unit 15 and the heat medium heat releasing unit 16, which has passed through the heat absorbing unit 14. The air mix damper 17 is provided upstream of the heat medium heat releasing unit 16 and the heat releasing unit bypass flow passage 11c in the air flow direction, and configured to close the upstream side of one of the heat releasing unit bypass flow passage 11c and the heat medium heat releasing unit 16 and open the other in the air flow direction, or open both the heat releasing unit bypass flow passage 11c and the heat medium heat releasing unit 16 to adjust the degree of opening of the upstream side of the heat medium heat releasing unit 16 in the air flow direction. The degree of opening of the air mix damper 17 is 0% when the upstream side of the heat medium heat releasing unit 16 in the air flow direction of the air flow passage 11 is closed and the heat releasing unit bypass flow passage 11c is open. On the other hand, the degree of opening of the air mix damper 17 is 100% when the upstream side of the heat medium heat releasing unit 16 in the air flow direction of the air flow passage 11 is open and the heat releasing unit bypass flow passage 11c is closed.

The refrigerant circuit 20 includes: the heat absorbing unit 14; the heat releasing unit 15; a compressor 21 configured to compress a refrigerant; an outdoor heat exchanger 22 configured to perform a heat exchange between the refrigerant and the air outside the vehicle compartment; a heat medium heat exchanger 23 configured to perform a heat exchange between the refrigerant flowing through the refrigerant circuit 20 and the heat medium flowing through the heat medium circuit 30; first to third expansion valves 24a, 24b and 24c having degrees of opening which can be adjusted from the full close to the full open; first and second solenoid valves 25a and 25b configured to open and close the refrigerant flow passage; first and second check valves 26a and 26b configured to control the flow direction of the refrigerant in the refrigerant flow passage; and an accumulator 27 configured to separate between gaseous refrigerant and liquid refrigerant to prevent the liquid refrigerant from being sucked into the compressor 21. These components are connected by, for example, an aluminum pipe or a copper pipe. As the refrigerant flowing through the refrigerant circuit 20, for example, R-134a may be used.

To be more specific, the input side of the heat releasing unit 15 into which the refrigerant flows is connected to the delivery side of the compressor 21 from which the refrigerant is discharged, thereby to form a refrigerant flow passage 20a. Meanwhile, the input side of the outdoor heat exchanger 22 into which the refrigerant flows is connected to the output side of the heat releasing unit 15 from which the refrigerant is discharged, thereby to form a refrigerant flow passage 20b. The first expansion valve 24a is provided in the refrigerant flow passage 20b. The input side of the heat absorbing unit 14 into which the refrigerant flows is connected to the output side of the outdoor heat exchanger 22 from which the refrigerant is discharged, thereby to form a refrigerant flow passage 20c. The first solenoid valve 26a and the second expansion valve 24b are provided in the refrigerant flow passage 20c in the order from the outdoor heat exchanger 22 side. The suction side of the compressor 21 into which the refrigerant is sucked is connected to the output side of the heat absorbing unit 14 from which the refrigerant is discharged, thereby to form a refrigerant flow passage 20d. The second check valve 26b and the accumulator 27 are provided in the refrigerant flow passage 20d in the order from the heat absorbing unit 14 side. A portion of the refrigerant flow passage 20c between the first check valve 26a and the second expansion valve 24b is connected to a portion of the refrigerant flow passage 20b between the heat releasing unit 15 and the first expansion valve 24a, bypassing the outdoor heat exchanger 22, thereby to form a refrigerant flow passage 20e. The first solenoid valve 25a is provided in the refrigerant flow passage 20e. The input side of the heat medium heat exchanger 23 into which the refrigerant flows is connected to a portion of the refrigerant flow passage 20e downstream of the first solenoid valve 25a, thereby to form a refrigerant flow passage 20f. The third expansion valve 24c is provided in the refrigerant flow passage 20f. A portion of the refrigerant flow passage 20d between the second check valve 26b and the accumulator 27 is connected to the output side of the heat medium heat exchanger 23 from which the refrigerant is discharged, thereby to form a refrigerant flow passage 20g. A portion of the refrigerant flow passage 20d between the heat absorbing unit 14 and the second check valve 26b is connected to a portion of the refrigerant flow passage 20c between the outdoor heat exchanger 22 and the first check valve 26a, thereby to form a refrigerant flow passage 20h. The second solenoid valve 25b is provided in the refrigerant flow passage 20h.

The outdoor heat exchanger 22 is a heat exchanger constituted by fins and tubes, and is disposed outside the compartment, for example, in an engine room, in the front-to-back direction of the vehicle which is the air flow direction. An outdoor blower 22a is provided in the vicinity of the outdoor heat exchanger 22 to flow the air outside the vehicle compartment in the front-to-back direction when the vehicle is stopped.

The heat medium circuit 30 includes: the heat medium heat releasing unit 16; the heat medium heat exchanger 23; first and second heat medium pumps 31a and 31b configured to pump the heat medium; a heat medium heater 32 configured to heat the heat medium flowing through the heat medium circuit 30; first to third heat medium three-way valves 33a, 33b and 33c; and the battery B configured to accumulate electric power and supply the electric power to the electric motor for driving the vehicle. These components are connected by, for example, an aluminum pipe or a copper pipe. As the heat medium flowing through the heat medium circuit 30, antifreeze solution, for example, ethyleneglycol may be used.

To be more specific, the input side of the first heat medium three-way valve 33a into which the heat medium flows is connected to the delivery side of the first heat medium pump 31a from which the heat medium is discharged, thereby to form a heat medium flow passage 30a. The heat medium heater 32 is provided in the heat medium flow passage 30a. The input side of the second heat medium three-way valve 33b into which the heat medium flows is connected to one of two heat medium outlets of the first heat medium three-way valve 33a, thereby to form a heat medium flow passage 30b as a heat releasing unit bypass flow passage. The input side of the battery B into which the heat medium flows is connected to one of two heat medium outlets of the second heat medium three-way valve 33b, thereby to form a heat medium flow passage 30c. A heat medium inlet of the third heat medium three-way valve 33c is connected to the output side of the battery B from which the heat medium is discharged, thereby to form a heat medium flow passage 30d. The suction side of the first heat medium pump 31a into which the heat medium is sucked is connected to one of two heat medium outlets of the third heat medium three-way valve 33c, thereby to form a heat medium flow passage 30e. The input side of the heat medium heat releasing unit 16 into which the heat medium flows is connected to the other heat medium outlet of the first heat medium three-way valve 33a, thereby to form a heat medium flow passage 30f. The heat medium flow passage 30b is connected to the output side of the heat medium heat releasing unit 16 from which the heat medium is discharged, thereby to form a heat medium flow passage 30g. The heat medium flow passage 30e is connected to the other heat medium outlet of the second heat medium three-way valve 33b, thereby to form a heat medium flow passage 30h as a component bypass flow passage. The suction side of the second heat medium pump 31b into which the heat medium is sucked is connected to the other heat medium outlet of the third heat medium three-way valve 33c, thereby to form a heat medium flow passage 30i. The input side of the heat medium heat exchanger 23 into which the heat medium flows is connected to the delivery side of the second heat medium pump 31b from which the heat medium is discharged, thereby to form a heat medium flow passage 30j. The heat medium flow passage 30c is connected to the output side of the heat medium heat exchanger 23 from which the heat medium is discharged, thereby to form a heat medium flow passage 30k. The first heat medium three-way valve 33a switches between the heat medium flow passage 30b and the heat medium flow passage 30f with which the heat medium flow passage 30a communicates. The second heat medium three-way valve 33b switches between the heat medium flow passage 30c and the heat medium flow passage 30h with which the heat medium flow passage 30b communicates. The third heat medium three-way valve 33c switches between the heat medium flow passage 30e and the heat medium flow passage 30i with which the heat medium flow passage 30d communicates.

The vehicle air conditioning apparatus 1 with the above-described configuration adjusts the temperature and the humidity of the air in the vehicle compartment, by using the air conditioning unit 10 and the refrigerant circuit 20.

For example, for the cooling operation to reduce the temperature of the vehicle compartment, the indoor blower 12 is actuated and the degree of opening of the air mix damper 17 is set to 0% in the air conditioning unit 10. In addition, the compressor 21 is actuated while the first expansion valve 24a is fully open, the second expansion valve 24b is open at a predetermined degree of opening, the third expansion valve 24c is fully closed, the first solenoid valve 25a is closed, and the second solenoid valve 25b is closed in the refrigerant circuit 20.

By this means, the refrigerant discharged from the compressor 21 flows through the refrigerant circuit 20 in the order of the refrigerant flow passage 20a, the heat releasing unit 15, the refrigerant flow passage 20b, the outdoor heat exchanger 22, the refrigerant flow passage 20c, the heat absorbing unit 14, and the refrigerant flow passages 20d, and is sucked into the compressor 21, as indicated by solid arrows in FIG. 1.

The refrigerant flowing through the refrigerant circuit 20 does not release the heat in the heat releasing unit 15 because the degree of opening of the air mix damper 17 is 0%, but releases the heat in the outdoor heat exchanger 22 and absorbs the heat in the heat absorbing unit 14.

The air flowing through the air flow passage 11 is subjected to a heat exchange with the refrigerant absorbing the heat in the heat absorbing unit 14, and therefore is cooled, and then blows to the vehicle compartment.

In addition, for example, for the cooling and dehumidifying operation to reduce the temperature and the humidity of the vehicle compartment, the degree of opening of the air mix damper 17 of the air conditioning unit 10 is set to a value greater than 0% in the refrigerant flow passage in the refrigerant circuit 20 for the cooling operation.

By this means, the refrigerant flowing through the refrigerant circuit 20 releases the heat in the heat releasing unit 15 and the outdoor heat exchanger 22, and absorbs the heat in the heat absorbing unit 14.

The air flowing through the air flow passage 11 is dehumidified and cooled by the heat exchange with the refrigerant absorbing the heat in the heat absorbing unit 14, and heated to the target air-blowing temperature in the heat releasing unit 15, and then blows to the vehicle compartment.

Moreover, for example, for the heating and dehumidifying operation to reduce the humidity and increase the temperature of the vehicle compartment, the degree of opening of the first expansion valve 24a is set to a predetermined value smaller than the full open in the refrigerant flow passage in the refrigerant circuit 20 for the cooling operation. In addition, the degree of opening of the air mix damper 17 of the air conditioning unit 10 is set to a value greater than 0%.

By this means, the refrigerant flowing through the refrigerant circuit 20 releases the heat in the heat releasing unit 15, and absorbs the heat in the outdoor heat exchanger 22 and the heat absorbing unit 14.

The air flowing through the air flow passage 11 of the air conditioning unit 10 is dehumidified and cooled by the heat exchange with the refrigerant absorbing the heat in the heat absorbing unit 14, and heated to the target air-blowing temperature in the heat releasing unit 15, and then blows to the vehicle compartment.

Meanwhile, for example, for the heating operation to increase the temperature of the vehicle compartment, the indoor blower 12 is actuated, and the degree of opening of the air mix damper 17 is set to a value greater than 0% in the air conditioning unit 10. In addition, the compressor 21 is actuated while the first expansion valve 24a is open at a predetermined degree of opening smaller than the full open, the second expansion valve 24b and the third expansion valve 24c are fully closed, the first solenoid valve 25a is closed, and the second solenoid valve 25b is open in the refrigerant circuit 20.

By this means, the refrigerant discharged from the compressor 21 flows through the refrigerant circuit 20 in the order of the refrigerant flow passage 20a, the heat releasing unit 15, the refrigerant flow passage 20b, the outdoor heat exchanger 22, part of the refrigerant flow passage 20c, the refrigerant flow passage 20h, and part of the refrigerant flow passage 20d, and is sucked into the compressor 21, as indicated by dashed arrows in FIG. 1.

The refrigerant flowing through the refrigerant circuit 20 releases the heat in the heat releasing unit 15, and absorbs the heat in the outdoor heat exchanger 22.

The air flowing through the air flow passage 11 of the air conditioning unit 10 is not subjected to a heat exchange with the refrigerant in the heat absorbing unit 14, but is subjected to a heat exchange with the refrigerant releasing the heat in the heat releasing unit 15 and therefore heated, and then blows to the vehicle compartment.

In addition, there is a case where the battery B needs to be heated, for example, a case where the vehicle is started to be driven under the condition of a low temperature. In the case where the battery B needs to be heated, the vehicle air conditioning apparatus 1 performs a battery heating operation.

For the battery heating operation, the flow path of the first heat medium three-way valve 33a is set to the heat medium flow passage 30b; the flow path of the second heat medium three-way valve 33b is set to the heat medium flow passage 30c; the flow path of the third heat medium three-way valve 33c is set to the heat medium flow passage 30e; the second heat medium pump 31b is not actuated; and the first heat medium pump 31a and the heat medium heater 32 are actuated in the heat medium circuit 30.

By this means, the heat medium discharged from the first heat medium pump 31a flows through the heat medium circuit 30 in the order of the heat medium flow passage 30a, the heat medium heater 32, the heat medium flow passages 30b and 30c, the battery B, and the heat medium flow passages 30d and 30e, and is sucked into the first heat medium pump 31a, as indicated by solid arrows in FIG. 1.

The heat medium flowing through the heat medium circuit 30 is heated by the heat medium heater 32. The battery B is heated by the heat medium which has been heated by the heat medium heater 32.

Meanwhile, there is a case where the battery B needs to be cooled because the battery B releases heat during the driving of the vehicle. In the case where the battery B needs to be cooled while the temperature and the humidity of the vehicle compartment are adjusted using the air conditioning unit 10 and the refrigerant circuit 20, the vehicle air conditioning apparatus 1 performs a battery cooling operation to cool the battery B.

For the battery cooling operation, the third expansion valve 24c is set to a predetermined degree of opening in the refrigerant circuit 20 for the operations except for the heating operation; and the third expansion valve 24c is set to a predetermined degree of opening, and the first solenoid valve 25a is open in the refrigerant circuit 20 for the heating operation. In addition, for the battery cooling operation, the flow path of the second heat medium three-way valve 33b is set to the heat medium flow passage 30h; the flow path of the third heat medium three-way valve 33c is set to the heat medium flow passage 30i; and the second heat medium pump 31b is actuated in the heat medium circuit 30.

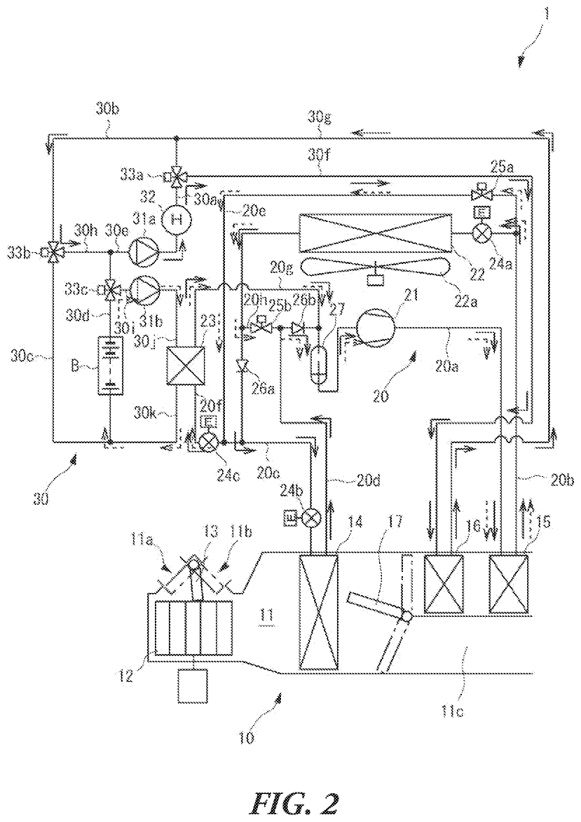

As illustrated in FIG. 2, in the refrigerant circuit 20, the refrigerant flows through the refrigerant flow passage 20f, flows into the heat medium heat exchanger 23, absorbs the heat in the heat medium heat exchanger 23, flows through the refrigerant flow passage 20g, flows into and together in the heat medium flow passage 20d, and then is sucked into the compressor 21.

Meanwhile, the heat medium discharged from the second heat medium pump 31b flows through the heat medium circuit 30 in the order of the heat medium flow passage 30j, the heat medium heat exchanger 23, the heat medium flow passages 30k and 30c, the battery B, and the heat medium heat passages 30d and 30i as a first circulating flow path, and then is sucked into the second heat medium pump 31b, as indicated by dashed arrows in FIG. 2. The heat medium flowing through the heat medium circuit 30 is heated by the heat released from the battery B, and cooled by a heat exchange with the refrigerant absorbing the heat in the heat medium heat exchanger 23.

The battery B is cooled by the heat medium having been subjected to the heat exchange with the refrigerant in the heat medium heat exchanger 23.

During the heating operation under the condition of a low temperature, there is a case where the temperature of the vehicle compartment cannot be a preset temperature because the amount of the heat released from the heat releasing unit 15 is insufficient. In the case where the amount of the heat released from the heat releasing unit 15 is insufficient while the heating operation is performed using the air conditioning unit 10 and the refrigerant circuit 20, the vehicle air conditioning apparatus 1 performs a heating assistive operation to assist the heating operation.

For the heating assistive operation, the flow path of the first heat medium three-way valve 33a is set to the heat medium flow passage 30f; the flow path of the second heat medium three-way valve 33b is set to the heat medium flow passage 30h; and the first heat medium pump 31a and the heat medium heater 32 are actuated in the heat medium circuit 30.

The heat medium discharged from the first heat medium pump 31a flows through the heat medium circuit 30 in the order of the heat medium flow passage 30a, the heat medium heater 32, the heat medium flow passage 30f, the heat medium heat releasing unit 16, and the heat medium flow passages 30g, 30b, 30h, and 30e as a second circulating flow path, and then is sucked into the first heat medium pump 31a, as indicated by solid arrows in FIG. 2.

The heat medium flowing through the heat medium circuit 30 is heated by the heat medium heater 32. The heat medium heated by the heat medium heater 32 does not flow through the battery B side, and releases the heat in the heat medium heat releasing unit 16.

The air flowing through the air flow passage 11 of the air conditioning unit 10 is heated by a heat exchange with the heat medium releasing the heat in the heat medium heat releasing unit 16, and heated to the target air-blowing temperature in the heat releasing unit 15, and then blows to the vehicle compartment.

As illustrated in FIG. 2, the first circulating flow path for the battery cooling operation and the second circulating flow path for the heating assistive operation can be set at the same time in the heat medium circuit 30 to flow the heat medium therethrough, respectively. Alternatively, in the heat medium circuit 30, one of the first heat medium pump 31a and the second heat medium pump 31b is actuated to allow the heat medium to flow through one of the first circulating flow path and the second circulating flow path.

Moreover, in a case where the battery B needs to be heated and the amount of the heat released from the heat releasing unit 15 is insufficient while the heating operation is performed using the air conditioning unit 10 and the refrigerant circuit 20, the vehicle air conditioning apparatus 1 performs a battery heating and heating assistive operation to heat the battery B and assist the heating operation.

For the battery heating and heating assistive operation, the flow path of the first heat medium three-way valve 33a is set to the heat medium flow passage 30f; the flow path of the second heat medium three-way valve 33b is set to the heat medium flow passage 30c; and the flow path of the third heat medium three-way valve 33c is set to the heat medium flow passage 30e in the heat medium circuit 30. In addition, for the battery heating and heating assistive operation, the second heat medium pup 31b is not actuated, but the first heat medium pump 31a and the heat medium heater 32 are actuated.

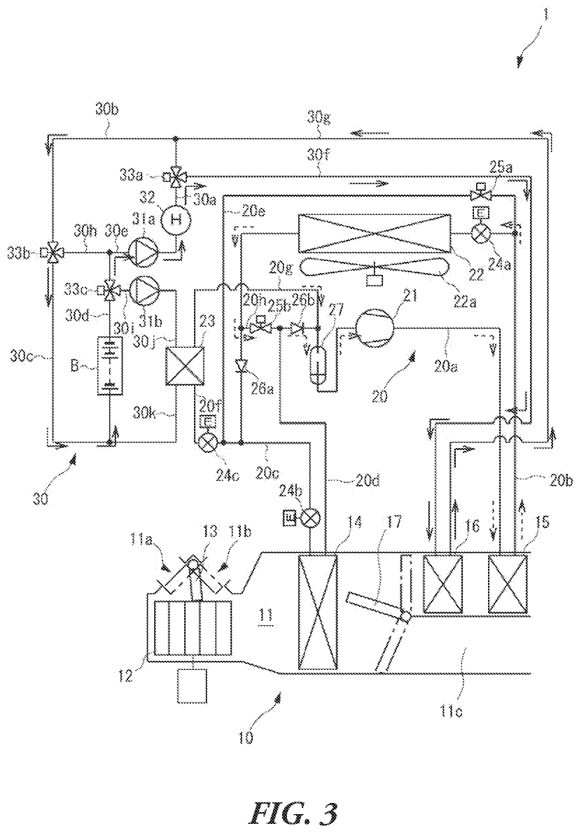

The heat medium discharged from the first heat medium pump 31a flows through the heat medium circuit 30 in the order of the heat medium flow passage 30a, the heat medium heater 32, the heat medium flow passage 30f, the heat medium heat releasing unit 16, the heat medium flow passages 30g, 30b, and 30c, the battery B, and the heat medium flow passages 30d, and 30e, and is sucked into the first heat medium pump 31a, as indicated by solid lines in FIG. 3.

The heat medium flowing through the heat medium circuit 30 is heated by the heat medium heater 32. The heat medium heated by the heat medium heater 32 releases the heat in the heat medium heat releasing unit 16, and then releases the heat in the battery B. The temperature of the heat medium required to heat the battery B is lower than the temperature of the heat medium required in the heat medium heat releasing unit 16. Therefore, the battery B is supplied with the heat medium which has already released the heat in the heat medium heat releasing unit 16.

The air flowing through the air flow passage 11 of the air conditioning unit 10 is heated by a heat exchange with the heat medium releasing the heat in the heat medium heat releasing unit 16, and heated to the target air-blowing temperature in the heat releasing unit 15, and then blows to the vehicle compartment.

Furthermore, during the heating operation, when the compressor 21 is stopped due to malfunction and so forth, and therefore to stop the refrigerant from flowing through the refrigerant circuit 20, a preliminary heating operation is performed using the heat medium circuit 30. For the preliminarily heating operation, the heat medium heated by the heat medium heater 32 does not flow through the battery B side, and releases the heat in the heat medium heat releasing unit 16, in the same way as the heating assistive operation.

In this way, the vehicle air conditioning apparatus according to the present embodiment includes the heat medium circuit 30 to which the heat medium heater 32 configured to heat the heat medium and the battery B are connected to allow the battery B to be heated by the heat medium flowing therethrough. The heat medium heat releasing unit 16 is connected to the heat medium circuit 30, which is provided downstream of the heat medium heater 32 and upstream of the battery B in the heat medium flow direction, and configured to release the heat from the heat medium to the air to be supplied to the vehicle compartment.

By this means, it is possible to use the heat medium heater 32 as a heat source for the heating operation, and therefore to perform the heating operation and heat the battery B by using one heater. Consequently, it is possible to save the installation space of the components of the vehicle, and reduce the manufacturing cost.

In addition, the heat medium circuit 30 includes the heat medium flow passage 30h as a component bypass flow passage to flow the heat medium therethrough, bypassing the battery B.

By this means, it is possible to heat the air flowing through the air flow passage 11 without heating the battery B, and therefore to prevent problems caused by excessively heating the battery B.

In addition, the heat medium circuit 30 includes the heat medium flow passage 30b as a heat releasing unit bypass flow passage to flow the heat medium, bypassing the heat medium heat releasing unit 16.

By this means, it is possible to heat the battery B without releasing the heat from the heat medium heat releasing unit 16. Therefore, it is possible to reduce the output of the heat medium heater 32 when the amount of the heat released from the heat releasing unit 15 is not insufficient, and consequently to save the energy consumption.

Moreover, the heat medium heat exchanger 23 configured to cool the heat medium by a heat exchange with the refrigerant flowing through the refrigerant circuit 20 is connected to the heat medium circuit 30.

By this means, it is possible to heat and cool the battery B by the one heat medium circuit 30. Consequently, it is possible to save the installation space of the components of the vehicle, and reduce the manufacturing cost.

Moreover, the first circulating flow path to circulate the heat medium between the battery B and the heat medium heat exchanger 23 and the second circulating flow path to circulate the heat medium between the heat medium heater 32 and the heat medium heat releasing unit 16 can be set at the same time in the heat medium circuit 30.

By this means, it is possible to heat the air to be supplied to the vehicle compartment and cool the battery B at the same time in the heat medium circuit 30. Consequently, it is possible to improve the comfort of the passengers while maintaining the performance of the vehicle.

Moreover, the heat medium heat releasing unit 16 is provided upstream of the heat releasing unit 15 in the air flow passage 11.

By this means, the air having a relatively low temperature before being heated in the heat releasing unit 15 can be heated by the heat medium. Therefore, it is possible to eliminate the need of a high-power heat medium heater to heat the heat medium to a high temperature, and consequently to reduce the manufacturing cost.

Furthermore, the preliminarily heating function is provided to heat the air to be supplied to the vehicle compartment by flowing the heat medium heated by the heat medium heater 32 through the heat medium heat releasing unit 16 while stopping the refrigerant from flowing in the refrigerant circuit 20.

By this means, even when the compressor 21 is stopped due to malfunction and so forth to stop the refrigerant from flowing through the refrigerant circuit 20, it is possible to continue to heat the vehicle compartment by the heat medium heater 32. Consequently, it is possible to avoid such a situation that the vehicle compartment cannot be heated under the condition of a low temperature.

Here, with the above-described embodiment, the battery B is illustrated as a component of the vehicle which needs to adjust the temperature, but this is by no means limiting. As components of the vehicle which need to adjust the temperature, for example, a power supply device such as a converter, an electronic part, and an electric motor may be applicable. In addition, a plurality of components of the vehicle may be connected to each other in parallel to adjust the temperatures, respectively.

Moreover, with the above-described embodiment, the antifreeze solution is used as the heat medium flowing through the heat medium circuit 30, but this is by no means limiting. For example, water and oil may be used as the heat medium as long as it can be subjected to a heat exchange with the refrigerant in the heat medium heat exchanger 23, and also can be subjected to a heat exchange with the air in the heat medium heat releasing unit 16.

Furthermore, with the above-described embodiment, the insufficient amount of the heat of the heating operation using the air conditioning unit 10 and the refrigerant circuit 20 is compensated by the heat medium heater connected to the heat medium circuit 30, but this is by no means limiting. For example, the heat medium circuit 30 according to the embodiment may be applied to a cooling only vehicle air conditioning apparatus, and the heat medium heater may be used as a heat source for the heating operation.

### REFERENCE SIGNS LIST

1 vehicle air conditioning apparatus, 10 air conditioning unit, 11 air flow passage, 14 heat absorbing unit, 15 heat releasing unit, 16 heat medium heat releasing unit, 20 refrigerant circuit, 21 compressor, 22 outdoor heat exchanger, 23 heat medium heat exchanger, 30 heat medium circuit, 32 heat medium heater, B battery.

1. A vehicle air conditioning apparatus configured to adjust a temperature and a humidity of air in a vehicle compartment, wherein
the vehicle air conditioning apparatus comprising a heat medium circuit to which a heat medium heater configured to heat a heat medium and a component of a vehicle are connected to allow the component to be heated by the heat medium flowing therethrough, and
a heat medium heat releasing unit being connected to the heat medium circuit, the heat medium heat releasing unit being provided downstream of the heat medium heater and upstream of the component in a heat medium flow direction, and configured to release heat from the heat medium to the air to be supplied to the vehicle compartment.

2. The vehicle air conditioning apparatus according to claim 1, wherein the heat medium circuit includes a component bypass flow passage configured to flow the heat medium therethrough, bypassing the component.

3. The vehicle air conditioning apparatus according to claim 1, wherein the heat medium circuit includes a heat releasing unit bypass flow passage configured to flow the heat medium therethrough, bypassing the heat medium heat releasing unit.

4. The vehicle air conditioning apparatus according to claim 1, further comprising a refrigerant circuit including:
a compressor;
an indoor heat exchanger;
an outdoor heat exchanger; and
expansion valves,
wherein the air supplied to the vehicle compartment is cooled or heated by a heat exchange with a refrigerant in the indoor heat exchanger, and
a heat medium heat exchanger configured to cool the heat medium by the heat exchange with the refrigerant flowing through the refrigerant circuit is connected to the heat medium circuit.

5. The vehicle air conditioning apparatus according to claim 4, wherein:
the heat medium heat releasing unit and the heat medium heat exchanger are connected in parallel to one another to the heat medium circuit; and
a first circulating flow path to circulate the heat medium between the component and the heat medium heat exchanger and a second circulating flow path to circulate the heat medium between the heat medium heater and the heat medium heat releasing unit can be set at the same time in the heat medium circuit.

6. The vehicle air conditioning apparatus according to claim 1, wherein the heat medium heat releasing unit is disposed upstream of the indoor heat exchanger which functions as a heat releasing unit in an air flow passage of the air to be supplied to the vehicle compartment.

7. The vehicle air conditioning apparatus according to claim 1, comprising a preliminarily heating function to heat the air to be supplied to the vehicle compartment by flowing the heat medium heated by the heat medium heater through the heat medium heat releasing unit while stopping the refrigerant from flowing in the refrigerant circuit.

8. The vehicle air conditioning apparatus according to claim 2, wherein the heat medium circuit includes a heat releasing unit bypass flow passage configured to flow the heat medium therethrough, bypassing the heat medium heat releasing unit.

9. The vehicle air conditioning apparatus according to claim 2, further comprising a refrigerant circuit including:
a compressor;
an indoor heat exchanger;
an outdoor heat exchanger; and
expansion valves,
wherein the air supplied to the vehicle compartment is cooled or heated by a heat exchange with a refrigerant in the indoor heat exchanger, and
a heat medium heat exchanger configured to cool the heat medium by the heat exchange with the refrigerant flowing through the refrigerant circuit is connected to the heat medium circuit.

10. The vehicle air conditioning apparatus according to claim 3, further comprising a refrigerant circuit including:
a compressor;
an indoor heat exchanger;
an outdoor heat exchanger; and
expansion valves,
wherein the air supplied to the vehicle compartment is cooled or heated by a heat exchange with a refrigerant in the indoor heat exchanger, and
a heat medium heat exchanger configured to cool the heat medium by the heat exchange with the refrigerant flowing through the refrigerant circuit is connected to the heat medium circuit.

11. The vehicle air conditioning apparatus according to claim 2, wherein the heat medium heat releasing unit is disposed upstream of the indoor heat exchanger which functions as a heat releasing unit in an air flow passage of the air to be supplied to the vehicle compartment.

12. The vehicle air conditioning apparatus according to claim 3, wherein the heat medium heat releasing unit is disposed upstream of the indoor heat exchanger which functions as a heat releasing unit in an air flow passage of the air to be supplied to the vehicle compartment.

13. The vehicle air conditioning apparatus according to claim 4, wherein the heat medium heat releasing unit is disposed upstream of the indoor heat exchanger which functions as a heat releasing unit in an air flow passage of the air to be supplied to the vehicle compartment.

14. The vehicle air conditioning apparatus according to claim 5, wherein the heat medium heat releasing unit is disposed upstream of the indoor heat exchanger which functions as a heat releasing unit in an air flow passage of the air to be supplied to the vehicle compartment.

15. The vehicle air conditioning apparatus according to claim 2, comprising a preliminarily heating function to heat the air to be supplied to the vehicle compartment by flowing the heat medium heated by the heat medium heater through the heat medium heat releasing unit while stopping the refrigerant from flowing in the refrigerant circuit.

16. The vehicle air conditioning apparatus according to claim 3, comprising a preliminarily heating function to heat the air to be supplied to the vehicle compartment by flowing the heat medium heated by the heat medium heater through the heat medium heat releasing unit while stopping the refrigerant from flowing in the refrigerant circuit.

17. The vehicle air conditioning apparatus according to claim 4, comprising a preliminarily heating function to heat the air to be supplied to the vehicle compartment by flowing the heat medium heated by the heat medium heater through the heat medium heat releasing unit while stopping the refrigerant from flowing in the refrigerant circuit.

18. The vehicle air conditioning apparatus according to claim 5, comprising a preliminarily heating function to heat the air to be supplied to the vehicle compartment by flowing the heat medium heated by the heat medium heater through the heat medium heat releasing unit while stopping the refrigerant from flowing in the refrigerant circuit.

19. The vehicle air conditioning apparatus according to claim 6, comprising a preliminarily heating function to heat the air to be supplied to the vehicle compartment by flowing the heat medium heated by the heat medium heater through the heat medium heat releasing unit while stopping the refrigerant from flowing in the refrigerant circuit.
